(19) United States
(12) Patent Application Publication
(10) Pub. No.: US 2010/0093373 A1
(43) Pub. Date: Apr. 15, 2010

(54) BUSINESS ESTABLISHMENT POPULARITY BASED ON PERSON LOCATION TRACKING

(75) Inventors: Stefan OLSSON, Lund (SE); Anders WIHLBORG, Rydeback (SE); Darius KATZ, Malmo (SE); Jarkko INKI, Lund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/250,604

(22) Filed: Oct. 14, 2008

(51) Int. Cl. H04W 4/02

(52) U.S. Cl. 455/456.3

(57) ABSTRACT

A system receives information associated with locations of multiple people, where the information is derived based on each of the multiple people's use of an electronic device. The system cross-references the locations of the multiple people to locations of one or more places where people get together to determine a number of the multiple people who are located at the one or more places. The system further provides a visual representation of a popularity of each of the one or more places to a user device based on the determined number of the multiple people who are located at the one or more places.

### BACKGROUND

When a prospective customer determines that he or she wants to visit a certain type of business establishment (e.g., a restaurant, a grocery store, etc.), that prospective customer often has to rely on pure guesswork when deciding which business establishment to visit. Sometimes, the prospective customer relies on word of mouth from friends and/or relatives, or blindly selects a business establishment from the “yellow pages,” without any true knowledge or information about the quality and/or desirability of a given business establishment. Therefore, prospective customers of business establishments may have a difficult time selecting a business establishment to visit that is likely to result in a satisfying experience.

### SUMMARY

According to one aspect, a computer-implemented method may include receiving information associated with locations of a plurality of people, where the information is derived based on each of the plurality of people's use of an electronic device. The computer-implemented method may further include referencing the locations of the plurality of people to locations of one or more places where people get together to determine a number of the plurality of people who are located at the one or more places. The computer-implemented method may also include providing data for use in generating a visual representation of a popularity of each of the one or more places to a user device based on the determined number of the multiple people who are located at the one or more places.

Additionally, the information associated with the locations of the multiple people may include Global Positioning System (GPS) data.

Additionally, the electronic device comprises a cellular radiotelephone.

Additionally, the information associated with the locations of the multiple people may include geo-location data derived from cellular network triangulation techniques.

Additionally, the locations of the plurality of people may include current locations of the plurality of people.

Additionally, the locations of the plurality of people may include past locations of the plurality of people.

Additionally, the business establishments may include one or more of restaurants, casinos, theaters, bars, nightclubs, theme parks, public parks, or shopping stores.

Additionally, the user device may include one or more of a computer or a cellular radiotelephone.

Additionally, the computer-implemented method may include sorting the one or more places based on the popularity of each of the one or more places to generate a sorted list, where providing the data comprises providing the sorted list to the user device.

According to another aspect, a system may include a network interface configured to receive geo-location data associated with electronic devices carried by a plurality of people. The system may further include a processor configured to: locate each of the plurality of people at one or more business establishments based on the received geo-location data, and provide information for a representation that graphically depicts a number of the plurality of people at each of the one or more business establishments.

Additionally, the processor is further configured to store the locations of each of the plurality of people at the one or more business establishments in a database.

Additionally, the system may further include a database that stores geo-locations associated with the one or more business establishments, and where the processor is further configured to cross-reference the received geo-location data to the stored geo-locations associated with the one or more business establishments to locate each of the multiple people at the one or more business establishments.

Additionally, the network interface may be further configured to transmit the representation to a user device via a network.

Additionally, the processor may be further configured to: determine a popularity of each of the one or more business establishments based on the location of the multiple people at the one or more business establishments, where the representation indicates a popularity of the one or more business establishments.

Additionally, the geo-location data may include Global Positioning System (GPS) data.

Additionally, the network interface may be further configured to transmit the representation to a user device via a network.

According to a further aspect, a computer-readable medium containing instructions executable by at least one processor may include one or more instructions for receiving geo-location data associated with electronic devices carried by a plurality of people and one or more instructions for locating each of the multiple people at multiple different business establishments based on the received geo-location data. The computer-readable medium may further include one or more instructions for sorting the multiple business establishments among one another based on a number of the plurality of people determined to be located at each of the business establishments of the multiple business establishments and one or more instructions for providing the sorted multiple business establishments as a list that indicates a relative popularity of each of the business establishments of the multiple business establishments.

Additionally, the computer-readable medium may include one or more instructions for providing the list to second electronic devices.

Additionally, the geo-location data may include Global Positioning System (GPS) geo-location data.

Additionally, the geo-location data may be derived from cellular network triangulation techniques.

### BRIEF DESCRIPTION OF THE DRAWINGS

The accompanying drawings, which are incorporated in and constitute a part of this specification, illustrate one or more embodiments of the invention and, together with the description, explain the invention. In the drawings,

FIG. 1 illustrates an overview of an exemplary implementation in which geo-locations for people carrying and/or using electronic devices may be determined and used to ascertain a number of people at one or more business establishments;

FIG. 2 illustrates a network in which exemplary embodiments may be implemented;

FIG. 3 illustrates an exemplary architecture associated with a user device of the network of FIG. 2;

FIG. 4 illustrates a user device of FIG. 2 in an exemplary implementation where the user device includes a cellular radiotelephone;

FIG. 5 illustrates an exemplary architecture associated with the people tracking server of FIG. 2;

FIG. 6 illustrates an exemplary functional block diagram of the people tracking server of FIG. 5;

FIG. 7 is a flow diagram of an exemplary process for determining the popularity of business establishments based on geo-location information obtained via the carrying and use of user devices by people;

FIG. 8 illustrates the transmission of geo-location data from user devices to the people tracking server; and

FIG. 9 illustrates an exemplary interface that graphically depicts a number of people located at various business establishments.

### DETAILED DESCRIPTION

The following detailed description of the invention refers to the accompanying drawings. The same reference numbers in different drawings may identify the same or similar elements. Also, the following detailed description does not limit the invention.

Systems and/or methods described herein enable prospective customers to make more informed choices about which business establishments to visit by using popularity information derived from the current and/or past geo-locations of people who are visiting or have visited business establishments. The geo-locations of the people may be derived from electronic devices (e.g., cellular radiotelephones) carried and/or used by the people. The systems and/or methods disclosed herein, thus, obtain geo-location data associated with people carrying and/or using the electronic devices and uses that geo-location data to determine the location of the people relative to certain business establishments. Once the location of the people relative to the business establishments is determined, a number of people located at each business establishment in the aggregate may be identified. The number of people located at each business establishment may then be used an indication of a popularity of each business establishment. For example, a large number of people located at a certain restaurant relative to fewer people located at other restaurants can be used as an indication that the certain restaurant is more popular than the other restaurant. Prospective customers may view a graphical representation of the numbers of people located at the different business establishments to select a business establishment that they want to visit. The graphical representation may display current and/or past numbers of people located at the different business establishments.

### Overview

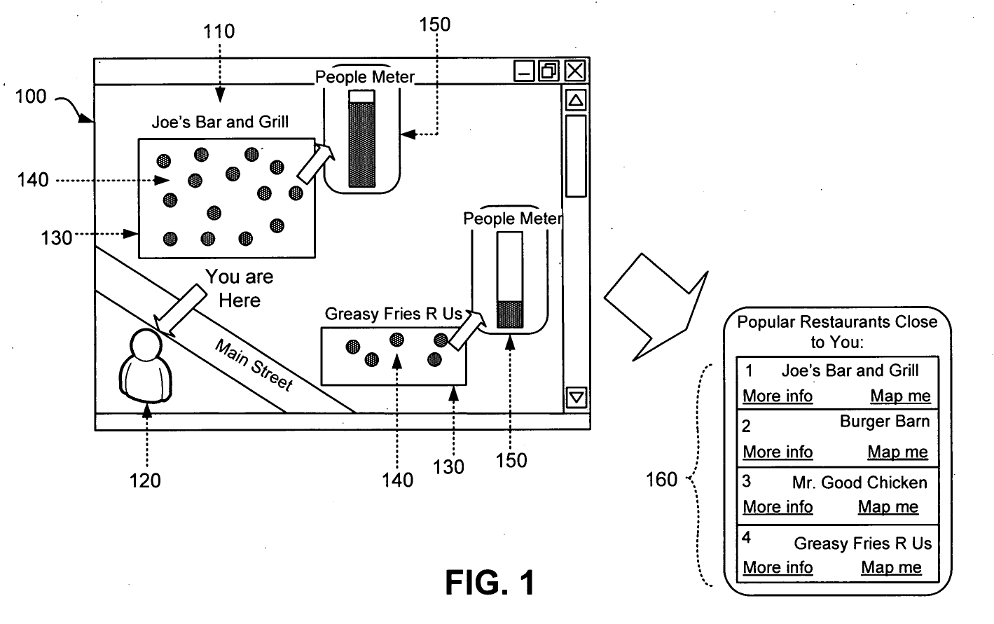

FIG. 1 is a diagram of an overview of an exemplary implementation in which geo-locations for people carrying and/or using electronic devices may be determined and used to ascertain a number of people at one or more business establishments. As shown in FIG. 1, a user interface 100 may present a map 110 of a geographic location. For example, as shown in FIG. 1, map 110 may depict a geographic location in a vicinity of a particular individual 120. In other implementations, map 110 may depict a geographic location specified by a particular individual. Prior to presenting the map, a people tracking server (not shown) may obtain geo-location information associated with people using electronic devices in the vicinity of the geographic location that is to be depicted on map 110. The geo-location information may be cross-referenced with the known locations of business establishments residing in the vicinity of the geographic location to determine how many people are located at each of the business establishments 130. A “business establishment,” as referred to herein, may include any place where people get together (e.g., for a common purpose or interest) including, but not limited to, places for eating, visiting art exhibitions, dancing, etc. These places can be either free of charge or involve an exchange of services or goods for money. A few examples of “business establishments” include restaurants, nightclubs, casinos, bars, theaters, concert arenas, theme parks, public parks and stores (e.g., grocery stores, clothing stores, a shopping mall, etc.).

In one exemplary implementation, a graphical representation 140 of each person located at a respective business establishment 130 may be shown on map 110. In another exemplary implementation, a “people meter” 150 may graphically depict an aggregated number of people per each business establishment. For example, as shown in FIG. 1, people meter 150 may include a bar graph the height of which indicates a number of people located at a respective business establishment.

In a further exemplary implementation, the number of people determined to be located at each business establishment may be used to determine a popularity of each of the business establishments and, in some implementations, to provide a sorted list 160 of the business establishments. In the sorted list, those business establishments having the most people may be sorted towards the top of the list (e.g., as the most popular). The business establishments may be sorted based additionally, in part, on other criteria (e.g., a proximity of the business establishment, a type of business establishment, etc.).

### Exemplary System

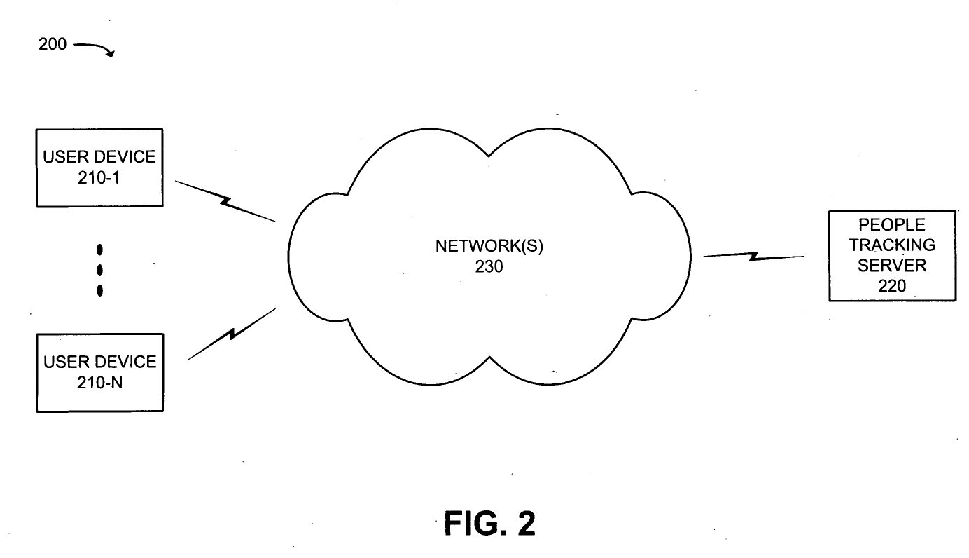

FIG. 2 illustrates a system 200 according to an exemplary embodiment. System 200 may include multiple user devices 210-1 through 210-N and a people tracking server 220 connected to a network 230 via wired or wireless links. Persons (not shown) may carry and/or use respective user devices 210-1 through 210-N.

User devices 210-1 through 210-N (referred to generically hereafter as “user device 210”) may include electronic devices, such as, for example, cellular radiotelephones, personal digital assistants (PDAs), Personal Communications Systems (PCS) terminals, computers (e.g., laptop or palmtop computers), or any other type of appliance that includes a communication transceiver that permits the devices to communicate via network 230. In some implementations, user devices 210-1 through 210-N may provide geo-location data (e.g., GPS geo-location data) to people tracking server 220.

People tracking server 220 may receive geo-location data from user devices 210-1 through 210-N (e.g., GPS geo-location data), from network 230 (e.g., via cellular triangulation), or from another source (not shown), and may reference that geo-location data to known locations of business establishments to determine how many people are currently located at each of the business establishments. The determined number of people at each of the business establishments may be used as an indicator of popularity of the business establishments. People tracking server 220 may provide a graphical representation of the number of people located at each of the business establishments to one or more of user devices 210-1 through 210-N via network 230.

Network(s) 230 may include one or more networks of any type, including a local area network (LAN); a wide area network (WAN); a metropolitan area network (MAN); a telephone network, such as the Public Switched Telephone Network (PSTN) or a Public Land Mobile Network (PLMN); an intranet, the Internet; or a combination of networks. The PLMN(s) may further include a packet-switched sub-network, such as, for example, General Packet Radio Service (GPRS), Cellular Digital Packet Data (CDPD), or Mobile IP sub-network.

### Exemplary User Device Architecture

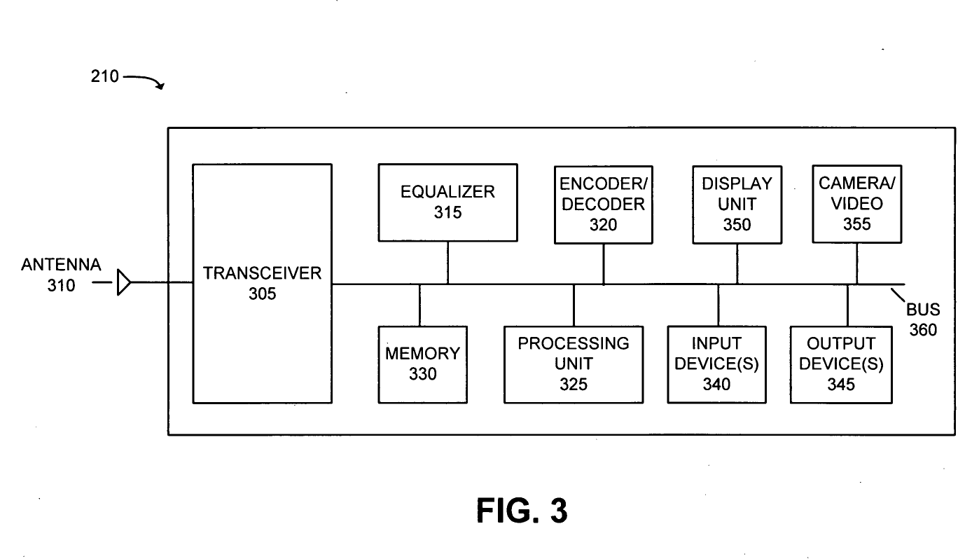

FIG. 3 is an exemplary diagram of an architecture of a user device 210. User device 210 may include a transceiver 305, an antenna 310, an equalizer 315, an encoder/decoder 320, a processing unit 325, a memory 330, an input device 340, an output device(s) 345, a display unit 350, a camera/video unit 355 and a bus 360.

Transceiver 305 may include known transceiver circuitry for transmitting and/or receiving symbol sequences using radio frequency signals via antenna 310. Transceiver 305 may include, for example, a RAKE receiver. Transceiver 305 may further include mechanisms for estimating the signal-to-interference ratio (SIR) of received symbol sequences. Transceiver 305 may additionally include mechanisms for estimating the propagation channel Doppler frequency.

Equalizer 315 may store and implement Viterbi trellises for estimating received symbol sequences using, for example, a maximum likelihood sequence estimation technique. Equalizer 315 may additionally include mechanisms for performing channel estimation. Encoder/decoder 320 may include circuitry for decoding and/or encoding received or transmitted symbol sequences. Processing unit 325 may perform all data processing functions for inputting, outputting, and processing of data including data buffering and terminal control functions, such as call processing control, user interface control, or the like.

Memory 330 may provide permanent, semi-permanent, or temporary working storage of data and instructions for use by processing unit 325 in performing processing functions. Memory 330 may include large-capacity storage devices, such as a magnetic and/or optical recording medium and its corresponding drive. Input device(s) 340 may include mechanisms for entry of data into device 210. Output device(s) 345 may include mechanisms for outputting data in audio and/or hard copy format.

Display unit 350 may include a screen display that may display images and/or video, and may also provide a graphical user interface that can be used by a user for selecting device 210 functions. The screen display of display unit 350 may include any type of visual display, such as, for example, an LCD display, a plasma screen display, an LED display, a CRT display, an OLED display, etc. Camera/video unit 355 may include existing camera and/or video devices for obtaining and storing images. Bus 360 may interconnect the various components of device 210 to permit the components to communicate with one another. The configuration of components of device 210 illustrated in FIG. 3 is for illustrative purposes only. Other configurations may be implemented.

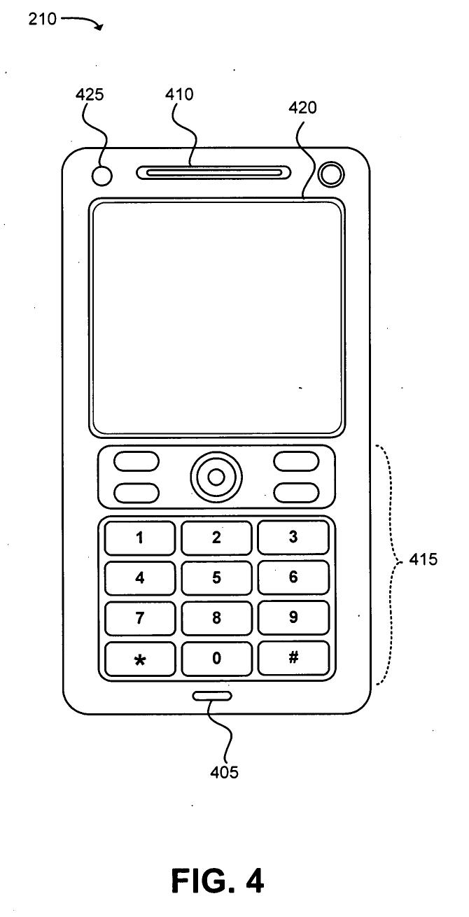

FIG. 4 illustrates an exemplary implementation of user device 210 in which user device 210 includes a cellular radiotelephone. As shown in FIG. 4, the cellular radiotelephone may include a microphone 405 (e.g., of input device(s) 340) for entering audio information into user device 210, a speaker 410 (e.g., of output device(s) 345) for providing an audio output from user device 210, a keypad 415 (e.g., of input device(s) 340) for manual entry of data or selection of device functions, and a display 420 (e.g., of display unit 350) that may visually display data to the user and/or which may provide a user interface that the user may use to enter data or to select device functions (in conjunction with keypad 415).

### Exemplary People Tracking Server Architecture

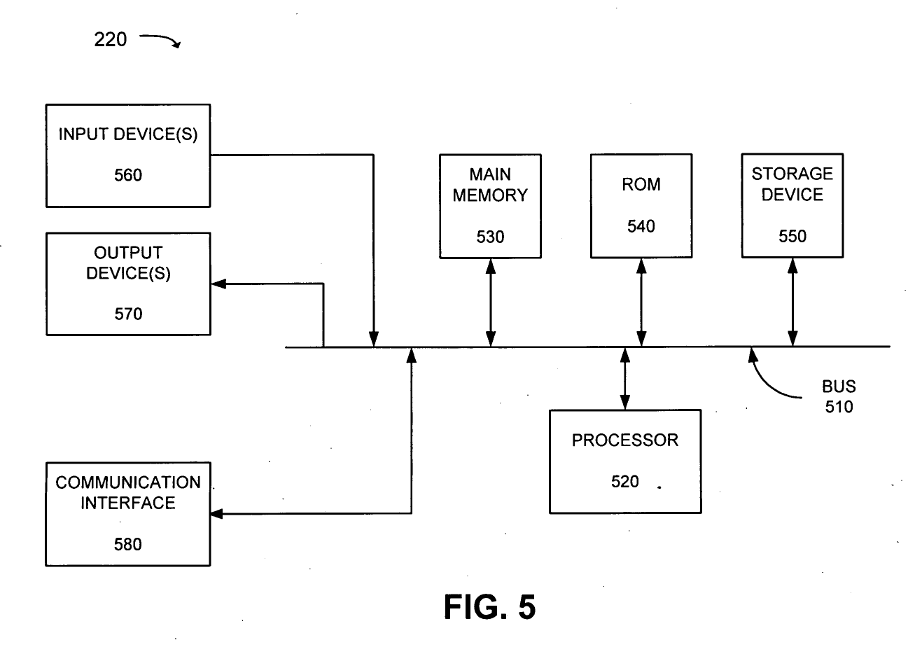

FIG. 5 is a diagram of an exemplary architecture of people tracking server 220. People tracking server 220 may include a bus 510, a processor 520, a main memory 530, a read only memory (ROM) 540, a storage device 550, an input device(s) 560, an output device(s) 570, and a communication interface 580. Bus 510 may include a path that permits communication among the elements of server 220.

Processor 520 may include a processor, microprocessor, or processing logic that may interpret and execute instructions. Main memory 530 may include a random access memory (RAM) or another type of dynamic storage device that may store information and instructions for execution by processor 520. ROM 540 may include a ROM device or another type of static storage device that may store static information and instructions for use by processor 520. Storage device 550 may include a magnetic and/or optical recording medium and its corresponding drive.

Input device 560 may include a mechanism that permits an operator to input information to server 220, such as a keyboard, a mouse, a pen, a touch screen, voice recognition and/or biometric mechanisms, etc. Output device 570 may include a mechanism that outputs information to the operator, including a display, a printer, a speaker, etc. Communication interface 580 may include any transceiver-like mechanism that enables server 220 to communicate with other devices and/or systems. For example, communication interface 580 may include mechanisms for communicating with another device or system via a network, such as network 230.

Server 220, consistent with exemplary implementations, may perform certain processes, as will be described in detail below. Server 220 may perform these processes in response to processor 520 executing software instructions contained in a computer-readable medium, such as memory 530. A computer-readable medium may include a physical or logical memory device.

The software instructions may be read into memory 530 from another computer-readable medium, such as data storage device 550, or from another device via communication interface 580. The software instructions contained in memory 530 may cause processor 520 to perform processes that will be described later. Alternatively, hardwired circuitry may be used in place of or in combination with software instructions to implement processes consistent with exemplary implementations. Thus, implementations are not limited to any specific combination of hardware circuitry and software.

### Exemplary People Tracking Server Functional Diagram

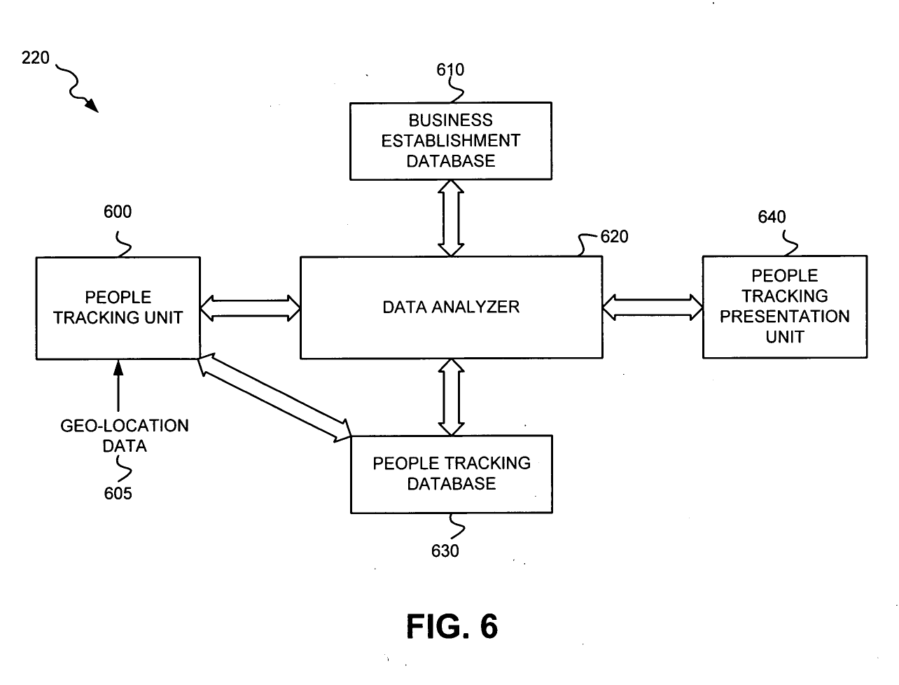

FIG. 6 depicts exemplary functional components of people tracking server 220. The functional components of people tracking server 220 may include a people tracking unit 600, a business establishment database 610, a data analyzer 620, a people tracking database 630, and a people tracking presentation unit 640.

People tracking unit 600 may receive geo-location data 605 associated with people carrying and/or using electronic devices. In one implementation, geo-location data 605 may be received from user devices 210-1 through 210-N via network 230. In such an implementation, geo-location data 605 may include, for example, Global Positioning System (GPS) data obtained from each of the users devices and forwarded to server 220 via network 230. In another implementation, geo-location data 605 may be received from components of network 230. In this implementation, geo-location data 605 may be derived from components of network 230 using, for example, known triangulation techniques that determine geo-locations of user devices 210-1 through 210-N. Geo-location data 605 may be obtained or derived from any type of ground or satellite-based system that can ascertain the geo-locations of people (e.g., based on their use or carrying of an electronic device). For example, geo-location data 605 may be derived from the U.S. or European satellite based GPS system, the Russian Global Orbiting Navigation Satellite system (GLONASS), Global System for Mobile Communications (GSM) sender/transmitter location determining mechanisms, or WLAN access points. People tracking unit 600 may store received geo-location data 605 in people tracking historical database 630.

Business establishment database 610 may include a data structure that stores various types of information about business establishments. Such information may include, for example, a name of a business establishment and a street address and a corresponding geo-location of the business establishment. The information may include other types of information, such as, for example, business hours, a description of products and/or services sold at the business establishment, etc.

Data analyzer 620 may cross-reference geo-location data 605 received by tracking unit 600 with business establishment geo-location data stored in database 610. For example, data analyzer 620 may cross-reference geo-location data 605 with business establishment geo-location data stored in database 610 to determine a number of people that are currently located at respective ones of the business establishments stored in database 610. Data analyzer 620 may store the determined number of people for the respective ones of the business establishments in people tracking historical database 630. Data analyzer 620 may, for example, determine the number of people that are currently located at respective ones of the business establishments at periodic intervals throughout each day and store the determined number of people in historical database 630. Data analyzer 620 may additionally determine a popularity of business establishments based on the determined number of people located at the business establishments. The determined popularity may be based on numbers of people currently located at respective ones of the business establishments, based on past numbers of people located at the business establishments, and/or based on current and past numbers of people located at the business establishments. Data analyzer 630 may further suggest/recommend business establishments to prospective customers based on the determined number of people currently located at respective ones of the business establishments (or based on historical patterns of numbers of people located at the business establishments).

People tracking database 630 may maintain a historical record of numbers of people located at business establishments. For example, database 630 may store a historical record that indicates how many people were located at a given business establishment at certain intervals (e.g., every 30 minutes).

People tracking presentation unit 640 may generate information that can be used by a user device to generate a graphical representation of business establishments, and their associated popularity as determined by data analyzer 620. Unit 640 may provide the graphical representation to one or more of user devices 210-1 through 210-N via network 230.

### Exemplary Process

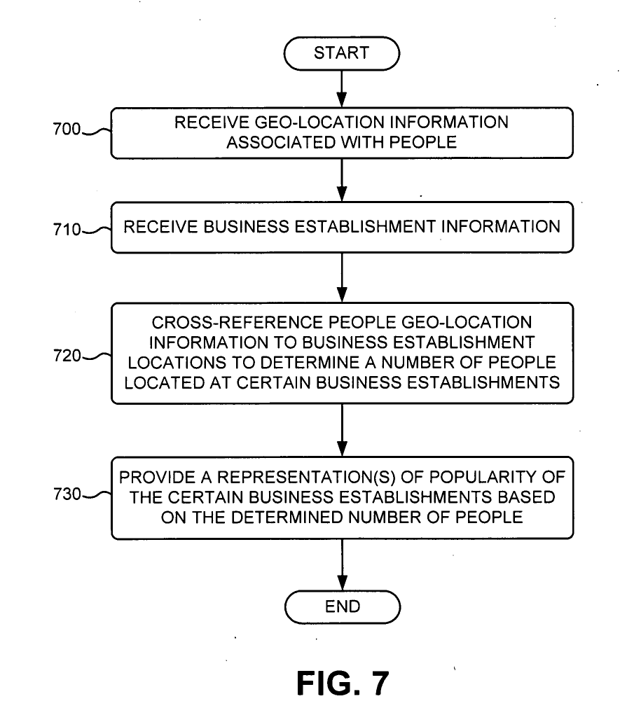

FIG. 7 is a flowchart of an exemplary process for determining the popularity of business establishments based on geo-location information obtained via the carrying and use of electronic user devices by people. The process exemplified by FIG. 7 may be performed by people tracking server 220. In one implementation, the exemplary process of FIG. 7 may be employed as a set of instructions stored in main memory 530 and executed by processor 520.

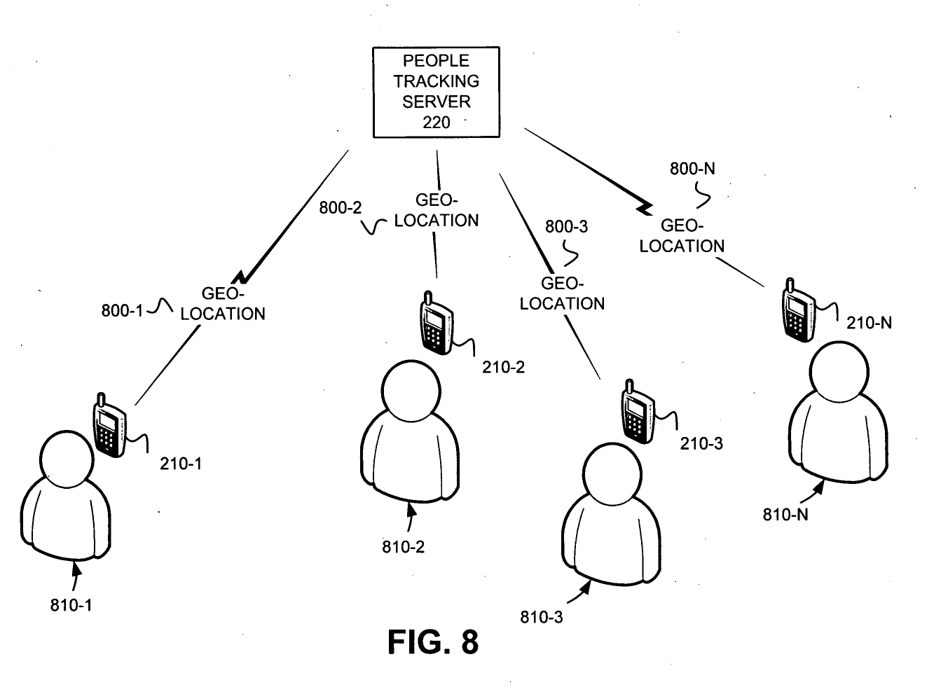

The exemplary process may begin with the receipt of geo-location information associated with people (block 700). FIG. 8 illustrates geo-location data 800-1 through 800-N being transmitted to people tracking server 220 from respective user devices 210-1 through 210-N carried by people 810-1 through 810-IN, according to an exemplary implementation. In the exemplary implementation of FIG. 8, geo-location data 800-1 through 800-N may include GPS geo-location data obtained at user devices 210-1 through 210-N using known techniques.

Returning to the process of FIG. 7, business establishment information may be received (block 710). For example, in one implementation, people tracking server 220 may receive business establishment information from an external source, such as a mapping service or other information service provider. The business establishment information may include names of business establishments, street addresses and corresponding geo-locations of the business establishments. The information may include other types of information, such as, for example, business hours, a description of products and/or services sold at the business establishments, etc. The received business establishment information may be stored in, and retrieved from, business establishment database 610.

The geo-location information associated with the people may be crossed-referenced with business establishment locations to determine a number of the people located at certain ones of the business establishments (block 720). For example, data analyzer 620 may compare the received geo-location data associated with people to business establishment location information retrieved from database 610 to determine a number of the people that are located at certain ones of the business establishments.

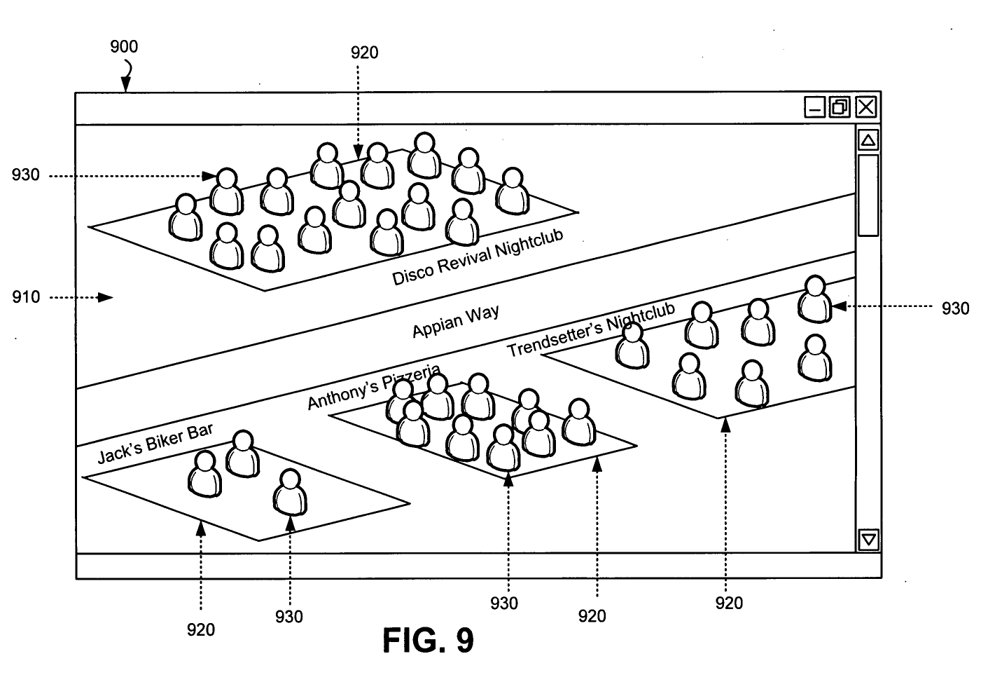

A representation(s) of the popularity of the certain business establishments may be provided based on the determined numbers of people (block 730). For example, presentation unit 640 may generate a graphical representation of the popularity of certain business establishments and provide the graphical representation to one or more of user devices 210-1 through 210-N. Presentation unit 640 may additionally provide a list of the business establishments where the business establishments are listed in an order determined by their relative popularity. Thus, in the sorted list, those business establishments having the most people may be sorted towards the top of the list (e.g., as the most popular). FIG. 9 illustrates an exemplary interface 900 provided to a user device 210 for display to a user. As shown, interface 900 includes a map 910 of business establishments 920 in a geographic area. A graphical representation 930 of a number of people located at each of business establishments 920 is further shown displayed in interface 900. A user at a user device 210 that views interface 900 may, thus, choose a specific business establishment to visit based on a current number of people located at the business establishments.

### Conclusion

Systems and/or methods described herein may enable prospective customers of business establishments to ascertain the popularity of business establishments that they may visit. A tracking server may determine geo-locations associated with electronic devices carried and/or used by people and may cross-reference those geo-locations with known geo-locations of business establishments to determine how many people are located at each of the business establishments. The determined number of people at each of the business establishments (either current or historical) may be used as an indicator of popularity. The tracking server may provide a graphical representation that indicates popularities associated with business establishments to prospective customers via a network (e.g., for display on their cellular radiotelephones).

The foregoing description of implementations provides illustration and description, but is not intended to be exhaustive or to limit the invention to the precise form disclosed. Modifications and variations are possible in light of the above teachings, or may be acquired from practice of the invention. For example, while a series of blocks has been described with regard to FIG. 7, the order of the blocks may be modified in other implementations. Further, non-dependent blocks may be performed in parallel.

It should be emphasized that the term “comprises” and/or “comprising” when used in this specification is taken to specify the presence of stated features, integers, steps, components or groups but does not preclude the presence or addition of one or more other features, integers, steps, components or groups thereof

It will be apparent that aspects described herein may be implemented in many different forms of software, firmware, and hardware in the implementations illustrated in the figures. The actual software code or specialized control hardware used to implement these aspects should not be construed as limiting. Thus, the operation and behavior of the aspects have been described without reference to the specific software code, it being understood that software and control hardware could be designed to implement the aspects based on the description herein.

Even though particular combinations of features are recited in the claims and/or disclosed in the specification, these combinations are not intended to limit the disclosure of the invention. In fact, many of these features may be combined in ways not specifically recited in the claims and/or disclosed in the specification.

No element, block, or instruction used in the present application should be construed as critical or essential to the invention unless explicitly described as such. Also, as used herein, the article “a” is intended to include one or more items. Where only one item is intended, the term “one,” “single,” or similar language is used. Further, the phrase “based on” is intended to mean “based, at least in part, on” unless explicitly stated otherwise.

What is claimed is:

1. A computer-implemented method, comprising:
receiving information associated with locations of a plurality of people, where the information is derived based on each of the plurality of people's use of an electronic device;
cross-referencing the locations of the plurality of people to locations of one or more places where people get together to determine a number of the plurality of people who are located at the one or more places; and
providing data for use in generating a visual representation of a popularity of each of the one or more places to a user device based on the determined number of the plurality of people who are located at the one or more places.

2. The computer-implemented method of claim 1, where the information associated with the locations of the plurality of people comprises Global Positioning System (GPS) data.

3. The computer-implemented method of claim 1, where the electronic device comprises a cellular radiotelephone.

4. The computer-implemented method of claim 1, where the information associated with the locations of the plurality of people comprises geo-location data derived from cellular network triangulation techniques.

5. The computer-implemented method of claim 1, where the locations of the plurality of people comprise current locations of the plurality of people.

6. The computer-implemented method 1, where the locations of the plurality of people comprise past locations of the plurality of people.

7. The computer-implemented method of claim 1, where the one or more places comprise one or more of restaurants, casinos, theaters, bars, nightclubs, theme parks, public parks, or shopping stores.

8. The computer-implemented method of claim 1, where the user device comprises a computer or a cellular radiotelephone.

9. The computer-implemented method of claim 1, further comprising:
sorting the one or more places based on the popularity of each of the one or more places to generate a sorted list,
where providing the data comprises providing the sorted list to the user device.

10. A system, comprising:
a network interface configured to receive geo-location data associated with electronic devices carried by a plurality of people;
a processor configured to:
locate each of the plurality of people at one or more business establishments based on the received geo-location data, and
provide information for a representation that graphically depicts a number of the plurality of people at each of the one or more business establishments.

11. The system of claim 10, where the processor is further configured to store the locations of each of the plurality of people at the one or more business establishments in a database.

12. The system of claim 10, further comprising:
a database that stores geo-locations associated with the one or more business establishments, and
where the processor is further configured to:
cross-reference the received geo-location data to the stored geo-locations associated with the one or more business establishments to locate each of the plurality of people at the one or more business establishments.

13. The system of claim 10, where the network interface is further configured to transmit the representation to a user device via a network.

14. The system of claim 10, where the processor is further configured to:
determine a popularity of each of the one or more business establishments based on the location of the plurality of people at the one or more business establishments,
where the representation indicates a popularity of the one or more business establishments.

15. The system of claim 10, where the geo-location data comprises Global Positioning System (GPS) data.

16. The system of claim 10, where the network interface is further configured to transmit the information for the representation to a user device via a network.

17. A computer-readable medium containing instructions executable by at least one processor, the computer-readable medium comprising:
one or more instructions for receiving geo-location data associated with first electronic devices carried by a plurality of people;
one or more instructions for locating each of the plurality of people at multiple different business establishments based on the received geo-location data,
one or more instructions for sorting the multiple business establishments among one another based on a number of the plurality of people determined to be located at each of the business establishments of the multiple business establishments; and
one or more instructions for providing the sorted multiple business establishments as a list that indicates a relative popularity of each of the business establishments of the multiple business establishments.

18. The computer-readable medium of claim 17, further comprising:
one or more instructions for providing the list to second electronic devices.

19. The computer-readable medium of claim 17, where the geo-location data comprises Global Positioning System (GPS) geo-location data.

20. The computer-readable medium of claim 17, where the geo-location data is derived from cellular network triangulation techniques.
